(19) United States
(12) Patent Application Publication
(10) Pub. No.: US 2004/0226043 A1
(43) Pub. Date: Nov. 11, 2004

(54) Location enabled television

(75) Inventors: Kumara Swamy Reddy Mettu, San Rafael, CA (US); Nemmara Chithambaram, Novato, CA (US)

Correspondence Address: GATES & COOPER LLP, HOWARD HUGHES CENTER, 6701 CENTER DRIVE WEST, SUITE 1050, LOS ANGELES, CA, 90045, US

(73) Assignee: Autodesk, Inc.

(21) Appl. No.: 10/839,454

(22) Filed: May 5, 2004

Related U.S. Application Data
(60) Provisional application No. 60/468,670, filed on May 7, 2003.

(51) Int. Cl. H04N 7/025; H04N 7/10; H04N 5/445; G06F 3/00; H04H 9/00; H04N 7/16

(52) U.S. Cl. 725/46; 725/34; 725/35

(57) ABSTRACT

A method, apparatus, and article of manufacture provide the ability to display personalized information on a television. A server obtains viewer-based information. The server then obtains customized information that is customized based on the viewer-based information. Audio/video information is then multiplexed with the customized information and broadcast using a satellite/cable, etc. The broadcast multiplexed information is received in a set top box (e.g., by a location logic application). The set top box causes the customized information to be displayed on a television communicatively coupled to the set top box.

### CROSS-REFERENCE TO RELATED APPLICATIONS

This application claims the benefit under 35 U.S.C. Section 119(e) of the following co-pending and commonly-assigned U.S. provisional patent application(s), which is/are incorporated by reference herein:

U.S. Provisional Patent Application Serial No. 60/468,670, entitled “LOCATION ENABLED TELEVISION”, by Kumara Swamy Reddy Mettu and Nemmara Chithambaram, filed on May 7, 2003, Attorney Docket No. 30566.238-US-P1.

### BACKGROUND OF THE INVENTION

1. Field of the Invention

The present invention relates generally to interactive television, and in particular, to a method, apparatus, and article of manufacture for delivering personalized solutions to users' television sets based on user location.

2. Description of the Related Art

Current broadcasts on television channels are targeted for broad audiences based on general demographics, and macro-regional analysis. For example, a broadcast may target a particular area such as the Bay Area and neighboring suburbs in Northern California. Alternatively, a broadcast may attempt to target a particular group such as 18-40 age group. However, there is little or no account of individual profile and location watching television. This lack of “location and individual profile awareness” results in generalized telecasts/broadcasts of dynamic content like traffic and weather that has a very low hit rate. In other words, users receiving such broadcasts may not be concerned with the content. Further, with interactive television, users may not “click” or view advertisements associated with such content. Accordingly, such a lack of “location and individual profile awareness” may severely limit the value of the commercial/advertisement content that is broadcast.

In view of the above, what is needed is the capability to account for location and individual profiles so that dynamic content may be customized based on a user's profile and location.

### SUMMARY OF THE INVENTION

One or more embodiments of the invention allow for location enabling of television broadcasts. Highly customized broadcasts (e.g. micro weather, traffic, etc.) may be provided by filtering the broadcast based on the viewer's location and profile. Further, the hit rate of commercial/advertisement broadcast may be significantly increased by offering aids to the viewer to locate the closest merchant, and by providing driving directions, weather, and/or traffic information on the chosen routes. Such location and profile enabling television may result in a better return on an investment for broadcast television commercials. Further, such enabling allows a mechanism to notify viewers of high priority traffic incidents and security breaches in and near a viewer's location based on a viewer's personal choices.

### BRIEF DESCRIPTION OF THE DRAWINGS

Referring now to the drawings in which like reference numbers represent corresponding parts throughout:

FIG. 1 illustrates a typical satellite television broadcast system in accordance with one or more embodiments of the invention;

FIG. 2 illustrates further details of the hardware environment for a content provider in accordance with one or more embodiments of the invention;

FIG. 3 illustrates the software stack on a set top box in accordance with one or more embodiments of the invention; and

FIG. 4 is a flow chart illustrating the logical flow for displaying personalized information on a television in accordance with one or more embodiments of the invention.

### DETAILED DESCRIPTION OF THE PREFERRED EMBODIMENTS

In the following description, reference is made to the accompanying drawings which form a part hereof, and which is shown, by way of illustration, several embodiments of the present invention. It is understood that other embodiments may be utilized and structural changes may be made without departing from the scope of the present invention.

Hardware Environment

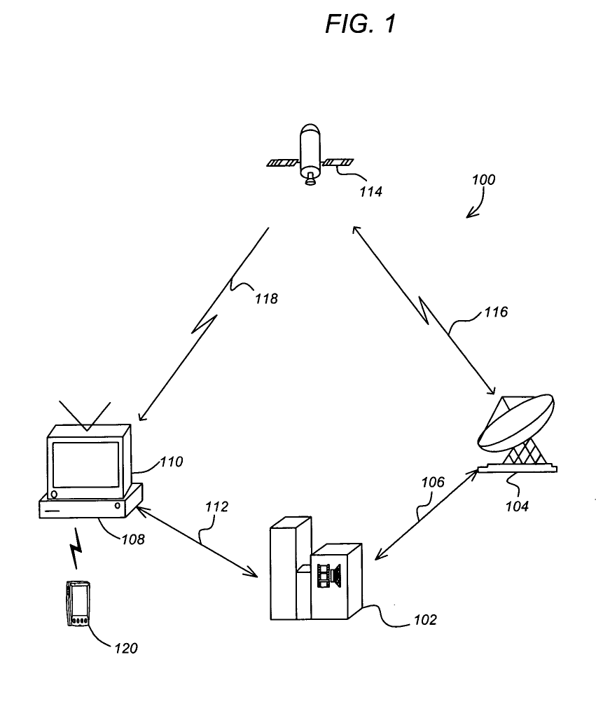

FIG. 1 illustrates a typical satellite television broadcast system 100 in accordance with one or more embodiments of the invention. The broadcast system 100 comprises a content provider 102 that communicates with a signal source 104 via a ground or other link 106 and with individual users having a set top box (STB) 108 connected to a television 110 via a telephone network or other link 112. The content provider 102 provides program content (e.g. video programs, audio programs and data) to the signal source 104 and coordinates with the STBs 108 to offer, for example, pay-per-view (PPV) program services, including billing and associated decryption of video programs on display device/television 110.

The signal source 104 receives program content and information that controls the content (referred to as program control information) from the content provider 102, and uses transmission equipment (e.g., a transmission antenna, cable, etc.) to transmit the program content and program control information through a distribution unit 114 (such as a cable control center or satellite) via signal 116. The distribution unit 114 receives and processes this information, and transmits the program content and program control information to the STBs 108 via signal 118. The STBs 108 receive and process the information for display on television 110. The information viewed and channels tuned may be controlled using buttons on the STB 108 itself or by a viewer using a device 120 communicatively coupled to the STB 108. For example, such a device 120 may comprise a remote control, handheld device (e.g., a personal digital assistant), cellular phone, smart card, portable electronic device, etc. Further, communication between the STB 108 and device 120 may be enabled through radio frequency (RF), infrared, wired transmissions, or any other transmission medium.

In view of the above, the STB 108 serves as a gateway between television 110 and telephone and satellite or cable feed (incoming signal). The STB 108 receives (directly or indirectly) encoded and/or compressed digital signals from the signal source 104 (e.g., a satellite, television station, cable network, etc.) and decodes (and/or decompresses) those signals, converting them into analog signals displayable on television 110. The STB 108 also accepts commands from the user (e.g., by use of a remote control, keypad, or keyboard) and may transmit these commands back to the network or content provider 102 (e.g., through a back channel 112).

While FIG. 1 illustrates a satellite based system 100, the present invention may also be practiced with terrestrial-based transmission, whether by broadcasting means, cable, or other means. Further, the different functions performed by the content provider 102 and the signal source 104 as described above can be reallocated as desired without departing from the intended scope of the present invention.

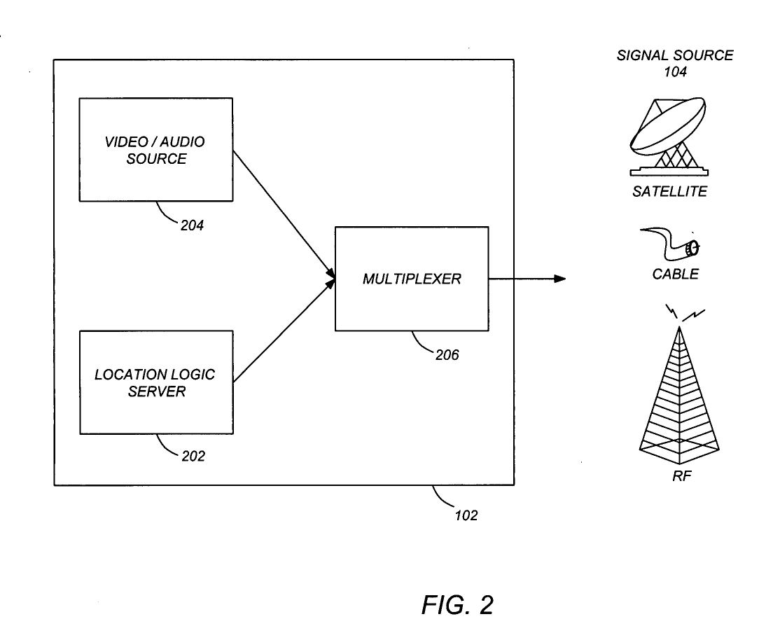

FIG. 2 illustrates further details of the hardware environment for content provider 102. As illustrated, a location logic television server 202 (described in further detail below) provides location based information using both pull and pushed based methods. The location logic server 202 information is combined with the regular video/audio source 204 at a multiplexer 206 and sent to STBs 108 via signal source 104 such as through satellite, cable, or RF transmissions.

Software Architecture

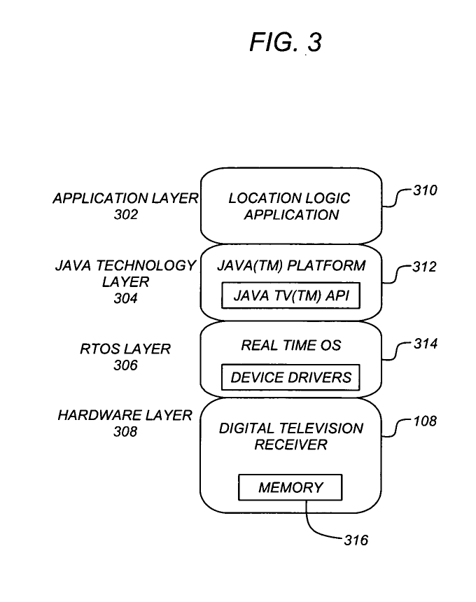

One or more embodiments provide the ability to deliver personalized solutions to user's television sets based on user location. As described above and illustrated in FIGS. 1 and 2, an STB 108 receives encoded and/or compressed signals, converting them into analog (or digital) signals for display on a television 110. Various applications may be executed by/within an STB 108 to provide useful functionality. FIG. 3 illustrates the software stack on an STB 108 in accordance with one or more embodiments of the invention.

The software stack typically has numerous layers including an application layer 302, Java™ technology layer 304, RTOS layer 306 and hardware layer 308. The bottom layer of the stack is the hardware layer 316 and essentially consists of the digital television receiver or STB 108. The next layer is the RTOS layer 306 that provides the system-level support, in the form of a real time operating system (RTOS) 314, needed to implement the Java™ technology layer 304. In addition, the RTOS 314 and related device-specific libraries may control the STB 108 through a collection of device drivers.

The Java™ technology layer 304 consists of a Java™ platform and a JavaTV™ API (application programming interface) 312. The Java™ platform may consist of a JVM (Java™ Virtual Machine). The JVM is software that converts Java™ intermediate language (bytecode) into machine language and executes it. The Java TV™ Application Programming Interface (API) is an extension of the Java™ platform, developed through an open process by Sun Microsystems and key leaders in the digital television industry.

Further details regarding the JavaTV™ API is provided in “JavaTM™ API Technical Overview: The Java TV API Whitepaper”, Version 1.0, Nov. 14, 2000 by Bart Calder, Jon Courtney, Bill Foote, Linda Kyrnitszke, David Rivas, Chihiro Saito, Maes Van Loo, Tao Ye available from Sun Microsystems, which is incorporated by reference herein. Further details may also be described in “The JavaTV™ API Overview: Setting the Standard for a Digital Future” available at http://java.sun.com/products/javatv/overview.html, 2002, and in “Java™ Technologies for Interactive Television, Technical White Paper,” 2001, by Sun Microsystems, both of which are incorporated by reference herein.

The Java TV™ API and platform 312 provides the support to execute JavaTV™ applications from the application layer 302. Another name for JavaTV™ applications are Xlets. Similar to applets, the software that runs the Xlet controls the Xlet. In the case of an applet, the underlying software is a browser or an applet viewer tool. In the case of an Xlet, the underlying software exists within the STB 108 in the form of the JavaTV™ API. Alternatively, any hardware executing within an STB 108 that can support the application may be used.

In view of the above, at the highest layer of the stack, the application layer 302, includes the location logic application 310. Such a location logic application may be in the form of an Xlet that is controlled by the JavaTV™ API. In addition, the invention may utilize a remote XML (extensible markup language) API provided by a location logic server 202. Further details regarding the XML API may be described in one or more of the following documents available at www.autodesk.com/locationservices which are incorporated by reference herein:

(1) “Autodesk Location Logic Technical Specifications”, 2003;

(2) “Introducing Autodesk Location Logic White Paper”, 2003;

(3) “Autodesk Location Logic: A Technical Overview”, 2003; and

(4) “Autodesk Location Logic Brochure”, 2002.

Profile/Location Information

As illustrated in FIG. 3, the STB 108 may include memory 316. Such memory may be used to store profile information for a user/viewer. For example, if the STB 108 is a digital video recorder (DVR), the memory 316 may store information regarding the viewing history (i.e., what has been viewed on the STB 108), the viewer's preferences, any channel lists (e.g., the user's favorite channels), viewing schedules, or anticipated recording options, etc. Alternatively, the memory 316 may merely store a profile identifier for a viewer. For example, an alphanumeric sequence may uniquely identify a viewer and be stored in the memory 316. Such a profile identifier may be used on the server-side by the location logic server 202.

The location logic server may use the profile information (e.g., a profile identifier) to detect/determine the viewer's location, profile, demographic classification, etc. from a server side database. Such a server side database may receive and store such information transmitted from the STB 108 (e.g., the viewing history, preferences, etc.). Alternatively, the server side database may accumulate such information as part of generally obtained/maintained subscription information (e.g., billing address for location, pay-per-view purchase history, subscription package selected, etc.).

Based on the location and profile, highly customized information (e.g., weather for that zip code, closest merchant or cinema location, driving directions, etc.) may be transmitted to the STB 108 and displayed on television 110. An example of the use of such customized information provides that a viewer watching a movie commercial on television in San Francisco may be given the option to reserve tickets at a local cinema (based on availability, distance, and traffic conditions) and also be provided with driving directions, weather, and traffic on that route.

As described above, the location logic server 202 may provide location based information to the STB 108 using both pull and push based methods. For example, location based information may be automatically pushed (e.g., transmitted/broadcast) to the STB by the location logic server 202. Alternatively, the STB 108 may pull the information from the location logic server 202 by requesting particular location based information (e.g., driving directions).

Software Embodiments

As described above, the invention allows the location enabling of digital television broadcasts. In this regard, various methods/systems may be used to location enable a broadcast.

In one or more embodiments, a location aware channel (referred to as MyLocation channel) may be provided on an enhanced STB 108. Such a location aware channel may broadcast micro weather, traffic information, etc. based on a viewer's location and/or profile.

In this regard, the location-aware channel may include broadcast commercials that have a series of user-selectable buttons displayed at the bottom of the screen. For example, a locate button may locate a merchant that is located closest to the individual who wants to purchase the advertised product. A route button may provide driving directions, etc. from the viewer's residence to the merchant's location. A traffic button may show traffic congestion on the route selected by the viewer. In this regard, the invention may provide notification of traffic incidents along the route irrespective of which channel the viewer is watching on an enhanced STB 108 (i.e., such traffic information may be displayed on a location-aware channel or on other channels [e.g., in a bar located along the peripheral of the screen or any other designated location]). Further, a weather button may show a micro weather report related to the route selected by the viewer.

Targeted Advertising

There are various options for providing targeted advertising in accordance with one or more embodiments of the invention. In one option, a particular advertisement is selected and displayed to the viewer based on the viewer's profile/location. In another option (or in addition to the location/profile based advertisement option), location based information may be multiplexed (e.g., by/at multiplexer 206) with the audio/video data.

In the first option (location/profile based advertisement), the location logic server 202 may determine the profile/location of a particular viewer (e.g., using a profile identifier and accessing a server-based database or by receiving the information from an STB 108) and broadcast/transmit (e.g., through a back channel) a particular advertisement that is targeted to the individual user.

In the second option, location based information is broadcast/transmitted with the national television advertisements. Such location based information may take multiple forms. For example, multiple advertisements may be broadcast along with the location based information. The location logic application 310 in the STB 108 may evaluate the location based information to determine which advertisement to display on the STB 108 (e.g., based on the STB 108 location or viewer profile).

In another form of the second option, the location based information provides additional enhanced services to the viewer. For example, the location based information may include additional services/information that can be invoked/utilized by the viewer. Thus, if a user decides to look for further information related to the advertisement, the location logic application 310 (e.g., executing as a Java TV Xlet in the STB 108) may display the nearest dealer information, driving directions, and/or any traffic congestions between the user's location and dealer location based. Such additional information may be displayed based on the user's selection of a button and/or settings pre-defined by the user (e.g., prior to receiving the broadcast). Accordingly, the invention enables location/profile based enhanced television services to a viewer.

Location Channel

As described above, a location channel may broadcast micro weather, traffic information, and security breaches based on a viewer's profile and/or location information. Such a location channel may be a particular channel that the STB 108 may be tuned to. Alternatively, the location channel may comprise location/based information/data that may be displayed by the STB 108 regardless of the channel currently being viewed by the user.

As described above, user profile/location information may be stored in memory 316 such as non-volatile RAM in the STB 108. The user profile/location information may include:

Traffic routes (selected or taken by the user in the past);

Temporal information on when the viewer desires to be notified of particular information (e.g., weather, traffic, etc.); and

Levels of notifications.

Thus, based on user preferences, the location logic application 310 executing in the STB 108, may determine when and what information to display on a television 110 attached to the STB 110. For example, popup information critical to the user may be displayed irrespective of the channel the user is watching. Such popup information may include traffic incidents along selected routes and/or security breaches in a geographic area (e.g., the viewer's geographic area). Further, such information may be displayed when the information is pushed by location logic television server 202 to the individual users' STBs 108.

User Scenarios

Various user scenarios are possible in accordance with one or more embodiments of the invention.

Location Enabled National Television Advertisement

When a user is watching television on a national broadcast, the user may find a commercial/advertisement interesting and desire to purchase the advertised product/service. The location logic application 310 running in the STB 108 enables the user to view the location of the nearest dealer for the product/service offered in the advertisement. Further the application 310 may optionally provide driving directions from the user's location to the dealer location and any traffic congestion/accidents in the driving directions.

Notification of Traffic Incidents Along User Routes

A user may configure customized routes and preferences using a computer or television remote control. For example, the user may specify a time and type of notification desired (e.g., specify a desire to be notified of any traffic incident along a desired route). The location/profile information may be stored on the location logic television server 202. When any traffic events occur during the user specified temporal intervals, the location logic server 202 may push the relevant information to the STB 108 for display. Accordingly, the user will be notified of the incidents irrespective of which channel the user is watching on the user's television 110.

Notification of Security Hazard Near User's Location

The user may configure specific locations and preferences regarding when to be notified of any security incidents. Such locations and preferences may be configured using the user's computer (e.g., that connects to a location logic server 202 via the Internet or other communication mechanism) or using a television remote control. The location/preference information is stored on the location logic television server 202 and when any security incidents occur in user specified locations, the user will be notified of the incidents irrespective of which channel the user is watching on television 110.

Browse Weather and Traffic By Tuning to a Location Channel

As described above, a location channel may be broadcast and contain location/profile based information. The user may click a button (e.g., on a remote control) to activate the location channel or tune into the location channel and view location/profile based information. For example, the user may check whether traffic incidents exist at user specified locations or along user specified routes.

Logical Flow

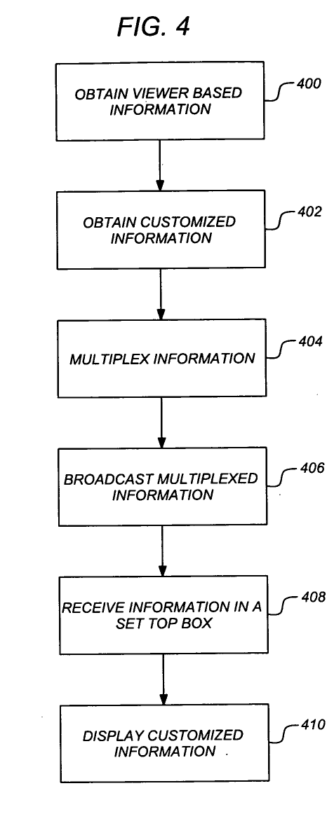

FIG. 4 is a flow chart illustrating the logical flow for displaying personalized information on a television in accordance with one or more embodiments of the invention. At step 400, viewer based information is obtained on a server. As described above, such viewer based information may be obtained by using an identifier that identifies a viewer (or a profile of a viewer) and retrieving information from a server-side database using the identifier. Alternatively, the information may be forwarded/transmitted by a set-top box that collects the information.

The viewer based information may take a variety of forms including a profile of a viewer, a location of a viewer, a traffic route, temporal information regarding when the viewer desires to be notified of the customized information, and/or levels of notifications (i.e., different levels wherein certain information is associated with a particular layer/level and a layer/level is presented to the user at a defined period of time or a upon the occurrence of a particular event [or type of event]).

At step 402, customized information is obtained. Such customized information is based on the viewer-based information. As described above, the customized information may be a targeted advertisement, a location where a product or service in the advertisement may be purchased, an enhanced service that may be selected by a user interactively through a set top box, etc. At step 404, audio/visual information (e.g., from a regular broadcast channel) is multiplexed with the customized information, and the multiplexed information is broadcast at step 406.

At step 408, the broadcast multiplexed information is received at a set top box. In this regard, a location logic application executing in the set top box (e.g., as a JavaTV™ Xlet) may receive the broadcast information. Accordingly, the information may either be pulled by the location logic application from the server or pushed by the server to the location logic application.

The application in the set top box then causes the customized information to be displayed on a television at step 410. Such displaying may be in the form of a pop up displayed over an audio/video channel (e.g., in accordance with user specified conditions) or may be on a location channel that the viewer may tune into using the set top box.

Conclusion

This concludes the description of the preferred embodiment of the invention. The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

What is claimed is:

1. A method for displaying personalized information on a television, comprising:
obtaining viewer-based information on a server;
obtaining customized information that is customized based on the viewer-based information;
multiplexing audio/video information with the customized information;
broadcasting the mutliplexed information;
receiving the broadcast multiplexed information in a set top box; and
displaying the customized information on a television communicatively coupled to the set top box.

2. The method of claim 1, wherein the step of obtaining viewer based information comprises:
receiving an identifier that identifies a viewer; and
retrieving viewer-based information from a server side database using the identifier.

3. The method of claim 1, wherein the viewer-based information comprises a profile of the viewer.

4. The method of claim 1, wherein the viewer-based information comprises a location of the viewer.

5. The method of claim 1, wherein the viewer-based information comprises a traffic route.

6. The method of claim 1, wherein the viewer-based information comprises temporal information regarding when the viewer desires to be notified of the customized information.

7. The method of claim 1, wherein the viewer-based information comprises levels of notifications.

8. The method of claim 1, wherein the server pushes the customized information to the set top box.

9. The method of claim 1, wherein the customized information is pulled to the set top box from the server.

10. The method of claim 1, wherein the customized information comprises advertisements targeted at the viewer based on the viewer-based information.

11. The method of claim 10, wherein the customized information further comprises location based information regarding a location where a product or service in the advertisement may be purchased.

12. The method of claim 1, wherein the customized information comprises enhanced services that may be selected by the viewer interactively through the set top box.

13. The method of claim 1, wherein the customized information is displayed in a channel that the viewer may tune into using the set top box.

14. The method of claim 1, wherein the customized information is displayed using a JavaTV™ Xlet.

15. A system for displaying personalized information on a television comprising:
(a) a set top box communicatively coupled to a television;
(b) a location logic application executing on the set top box, wherein the location logic application is configured to:
(i) receive broadcast multiplexed information from a server, wherein the multipliexed information comprises audio/video information that has been mutiplexed with customized information that is customized based on viewer-based information; and
(ii) cause the customized information to be displayed on the television.

16. The system of claim 15, wherein the server is configured to obtain the viewer based information by:
receiving an identifier that identifies a viewer; and
retrieving viewer-based information from a server side database using the identifier.

17. The system of claim 15, wherein the viewer-based information comprises a profile of the viewer.

18. The system of claim 15, wherein the viewer-based information comprises a location of the viewer.

19. The system of claim 15, wherein the viewer-based information comprises a traffic route.

20. The system of claim 15, wherein the viewer-based information comprises temporal information regarding when the viewer desires to be notified of the customized information.

21. The system of claim 15, wherein the viewer-based information comprises levels of notifications.

22. The system of claim 15, wherein the customized information is pushed to the location based application by the server.

23. The system of claim 15, wherein the location based application pulls the customized information from the server.

24. The system of claim 15, wherein the customized information comprises advertisements targeted at the viewer based on the viewer-based information.

25. The system of claim 24, wherein the customized information further comprises location based information regarding a location where a product or service in the advertisement may be purchased.

26. The system of claim 15, wherein the customized information comprises enhanced services that may be selected by the viewer interactively through the set top box.

27. The system of claim 15, wherein the customized information is displayed in a channel that the viewer may tune into using the set top box.

28. The system of claim 15, wherein the location logic application comprises a JavaTV™ Xlet.

29. An article of manufacture comprising a program storage medium readable by a set top box and embodying one or more instructions executable by the set top box to perform a method for displaying personalized information on a television, the method comprising:
receiving broadcast multiplexed information from a server, wherein the multipliexed information comprises audio/video information that has been mutiplexed with customized information that is customized based on viewer-based information; and
causing the customized information to be displayed on the television.

30. The article of manufacture of claim 29, wherein the viewer-based information is obtained by a server by:
receiving an identifier that identifies a viewer; and
retrieving viewer-based information from a server side database using the identifier.

31. The article of manufacture of claim 29, wherein the viewer-based information comprises a profile of the viewer.

32. The article of manufacture of claim 29, wherein the viewer-based information comprises a location of the viewer.

33. The article of manufacture of claim 29, wherein the viewer-based information comprises a traffic route.

34. The article of manufacture of claim 29, wherein the viewer-based information comprises temporal information regarding when the viewer desires to be notified of the customized information.

35. The article of manufacture of claim 29, wherein the viewer-based information comprises levels of notifications.

36. The article of manufacture of claim 29, wherein the server pushes the customized information to the set top box.

37. The article of manufacture of claim 29, wherein the customized information is pulled to the set top box from the server.

38. The article of manufacture of claim 29, wherein the customized information comprises advertisements targeted at the viewer based on the viewer-based information.

39. The article of manufacture of claim 38, wherein the customized information further comprises location based information regarding a location where a product or service in the advertisement may be purchased.

40. The article of manufacture of claim 29, wherein the customized information comprises enhanced services that may be selected by the viewer interactively through the set top box.

41. The article of manufacture of claim 29, wherein the customized information is displayed in a channel that the viewer may tune into using the set top box.

42. The article of manufacture of claim 29, wherein the customized information is displayed using a JavaTV™ Xlet.
